(19) United States
(12) Patent Application Publication
(10) Pub. No.: US 2024/0412717 A1
(43) Pub. Date: Dec. 12, 2024

(54) AIR AMPLIFIER WITH MULTI-STAGE NOISE SUPPRESSION SYSTEM

(71) Applicant: Sphere Entertainment Group, LLC, New York, NY (US)

(72) Inventors: Robert ANDERSON, Levittown, NY (US); Erik Hockman, New York, NY (US); Michael Rives, Orlando, FL (US)

(73) Assignee: Sphere Entertainment Group, LLC, New York, NY (US)

(21) Appl. No.: 18/808,836

(22) Filed: Aug. 19, 2024

Related U.S. Application Data
(63) Continuation-in-part of application No. 18/439,004, filed on Feb. 12, 2024.
Application No. 18/439,004 is a continuation-in-part of application No. 17/150,794, filed on Jan. 15, 2021, now Pat. No. 11,986,849.

(51) Int. Cl. G10K 11/16; F04F 5/16; G10K 11/172

(52) U.S. Cl. CPC G10K 11/161; F04F 5/16; G10K 11/172

(57) ABSTRACT

Exemplary air amplifiers described herein can utilize a high-pressure stream of gas to accelerate a low-velocity stream of gas to provide a high-velocity, high-volume stream of gas. This high-velocity, high-volume stream of gas can generate unwanted noise as the high-velocity, high-volume stream of gas propagates through the air amplifier. The exemplary air amplifiers described herein can include a multi-stage noise suppression system to suppress, for example, diminish, re-tune, or even completely cancel, the unwanted noise as the high-velocity, high-volume stream of gas propagates through these exemplary air amplifiers. The multi-stage noise suppression system can include one or more absorption materials to passively suppress the unwanted noise generated by the high-velocity, high-volume stream of gas. The multi-stage noise suppression system described herein can generate one or more noise suppression waves to actively suppress the unwanted noise generated by the high-velocity, high-volume stream of gas.

### CROSS-REFERENCE TO RELATED APPLICATIONS

The present application is a continuation-in-part of U.S. patent application Ser. No. 18/439,004, filed on Feb. 12, 2024, which is a continuation-in-part of U.S. patent application Ser. No. 17/150,794, filed Jan. 15, 2021, each of which is incorporated herein by reference in its entirety.

### BACKGROUND

The United States Media and Entertainment Industry is the largest in the world. The United States Media and Entertainment Industry represents a third of the global media and entertainment industry which delivers events, such as musical events, theatrical events, sporting events, and/or motion picture events, to an audience for their viewing pleasure. Operators of venues, such as music venues and/or sporting venues to provide some examples, have made many attempts to further enhance the immersion of the audience as they are viewing these events.

### BRIEF DESCRIPTION OF THE DRAWINGS

Aspects of the present disclosure are best understood from the following detailed description when read with the accompanying figures. It is noted that, in accordance with the standard practice in the industry, features are not drawn to scale. In fact, the dimensions of the features may be arbitrarily increased or reduced for clarity of discussion. In the accompanying drawings:

FIG. 1 graphically illustrates an exemplary air amplifier with multi-stage noise suppression system in accordance with some exemplary embodiments;

FIG. 2 graphically illustrates a first exemplary secondary noise suppressor that can be implemented within the exemplary air amplifier with multi-stage noise suppression system in accordance with some exemplary embodiments;

FIG. 3 graphically illustrates a second exemplary secondary noise suppressor that can be implemented within the exemplary air amplifier with multi-stage noise suppression system in accordance with some exemplary embodiments;

FIG. 4 graphically illustrates an exemplary multi-stage noise suppression system that can be implemented within the exemplary air amplifier with multi-stage noise suppression system in accordance with some exemplary embodiments;

FIG. 5 graphically illustrates a third exemplary secondary noise suppressor that can be implemented within the exemplary air amplifier with multi-stage noise suppression system in accordance with some exemplary embodiments;

FIG. 6A through FIG. 6C graphically illustrate exemplary inner faceplates that can be implemented within the exemplary secondary noise suppressors described herein in accordance with some exemplary embodiments;

FIG. 7 graphically illustrates various acoustic absorption chambers that can be implemented within the exemplary secondary noise suppressors described herein in accordance with some exemplary embodiments;

FIG. 8A through FIG. 8D graphically illustrate various exemplary active acoustic suppression chambers that can be implemented w within the exemplary secondary noise suppressors described herein in accordance with some exemplary embodiments; and

FIG. 9A through FIG. 9C graphically illustrate exemplary first inner face plates that can be implemented within the exemplary secondary noise suppressors described herein in accordance with some exemplary embodiments.

The present disclosure will now be described with reference to the accompanying drawings.

### DETAILED DESCRIPTION

The following disclosure provides many different embodiments, or examples, for implementing different features of the provided subject matter. Specific examples of components and arrangements are described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not in itself dictate a relationship between the various embodiments and/or configurations discussed. It is noted that, in accordance with the standard practice in the industry, features are not drawn to scale. In fact, the dimensions of the features may be arbitrarily increased or reduced for clarity of discussion.

### Overview

Exemplary air amplifiers described herein can utilize a high-pressure stream of gas to accelerate a low-velocity stream of gas to provide a high-velocity, high-volume stream of gas. This high-velocity, high-volume stream of gas can generate unwanted noise as the high-velocity, high-volume stream of gas propagates through the air amplifier. The exemplary air amplifiers described herein can include a multi-stage noise suppression system to suppress, for example, diminish, re-tune, or even completely cancel, the unwanted noise as the high-velocity, high-volume stream of gas propagates through these exemplary air amplifiers. The multi-stage noise suppression system can include one or more absorption materials to passively suppress the unwanted noise generated by the high-velocity, high-volume stream of gas. The multi-stage noise suppression system described herein can generate one or more noise suppression waves to actively suppress the unwanted noise generated by the high-velocity, high-volume stream of gas.

Exemplary Air Amplifier with Multi-Stage Noise Suppression System

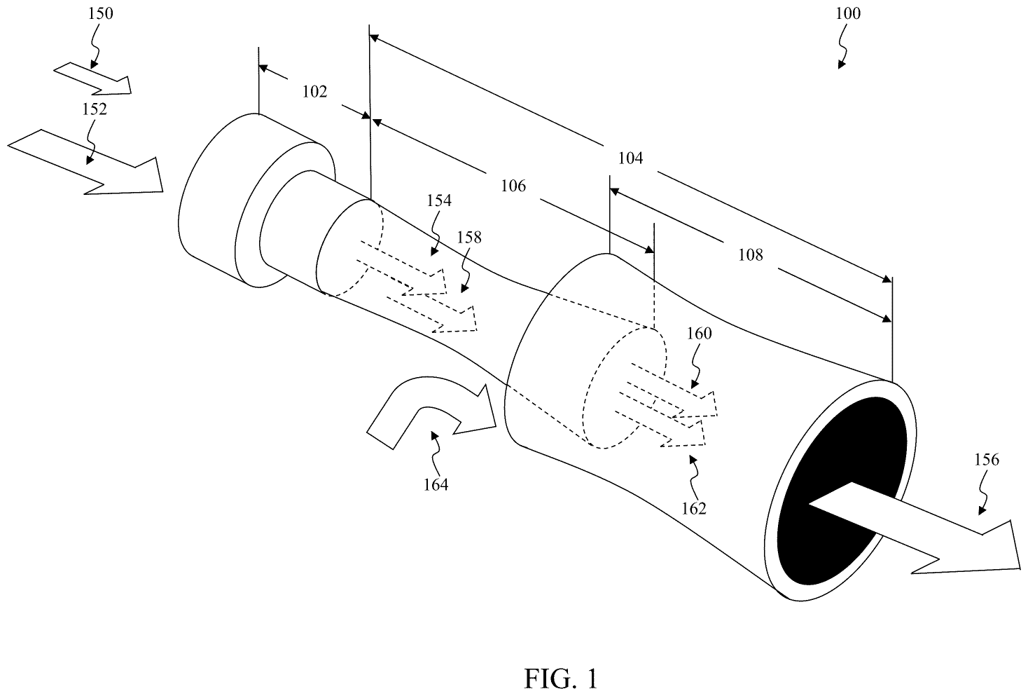

FIG. 1 graphically illustrates an exemplary air amplifier with multi-stage noise suppression system in accordance with some exemplary embodiments. As illustrated in FIG. 1, an air amplification system 100 utilizes a high-pressure stream of gas to accelerate a low-velocity stream of gas to provide a high-velocity, high-volume stream of gas. These streams of gas, as well as other streams of gas as described herein, can include any gaseous element, compound, and/or mixture of elements and/or compounds, for example, ambient air. Moreover, these streams of gas, as well as other streams of gas as described herein, can additionally, or alternatively, include any elements, compounds, and/or mixtures of elements and/or compounds that are in a gaseous state, for example, water in its gaseous state, also referred to as steam. As described herein, the high-velocity, high-volume stream of gas can generate unwanted noise as the high-velocity, high-volume stream of gas propagates through the air amplification system 100. As described herein, the air amplification system 100 can advantageously suppress, for example, diminish, re-tune, or even completely cancel, the unwanted noise as the high-velocity, high-volume stream of gas propagates through the air amplification system 100. In the exemplary embodiment illustrated in FIG. 1, the air amplification system 100 can include an air amplification engine 102 and a multi-stage noise suppression system 104.

The air amplification engine 102 utilizes energy from a high-pressure input stream of gas 150 to accelerate a low-velocity input stream of gas 152 to provide a high-velocity, high-volume input stream of gas 154. Generally, the air amplification engine 102 can direct the high-pressure input stream of gas 150 into a relatively narrow section of the air amplification engine 102. As the high-pressure input stream of gas 150 propagates through this relatively narrow section, the velocity of the high-pressure input stream of gas 150 increases which, according to the Venturi effect, causes the pressure to reduce in this relatively narrow section to form a lower pressure zone. The lower pressure zone within this relatively narrow section causes the low-velocity input stream of gas 152 to be drawn into the air amplification engine 102. The low-velocity input stream of gas 152 that is drawn into the air amplification engine 102 thereafter mixes, combines, diffuses, or the like with the high-pressure input stream of gas 150 to form the high-velocity, high-volume input stream of gas 154 that exits the air amplification engine 102 as illustrated in FIG. 1. In some embodiments, the air amplification engine 102 can be implemented as an air volume amplifier or an air pressure amplifier. In these embodiments, the air volume amplifier and/or the air pressure amplifier can be implemented as a standard, also referred to as a fixed, air amplifier or an adjustable, also referred to as a variable, air amplifier. In some embodiments, the air amplification engine 102 can be mechanically connected to the multi-stage noise suppression system 104 with various fasteners, such as nuts, screws, bolts, rivets, pins, and/or lags to provide some examples. Other features, structures, characteristics, or the like for the air amplification engine 102 are further described in U.S. patent application Ser. No. 16/997,511, filed on Aug. 19, 2020, now U.S. Pat. No. 11,260,314, U.S. patent application Ser. No. 17/150,794, filed on Jan. 15, 2021, now U.S. Pat. No. 11,986,849, and/or U.S. patent application Ser. No. 18/439,004, filed on Feb. 12, 2024, each of which is incorporated herein by reference in its entirety.

The multi-stage noise suppression system 104 can shape the high-velocity, high-volume input stream of gas 154 as the high-velocity, high-volume input stream of gas 154 propagates through the multi-stage noise suppression system 104 to provide a high-velocity, high-volume output stream of gas 156. In some embodiments, the multi-stage noise suppression system 104 can suppress, for example, diminish, re-tune, and/or even completely cancel, unwanted noise that is generated by the high-velocity, high-volume input stream of gas 154 as the high-velocity, high-volume input stream of gas 154 propagates through the multi-stage noise suppression system 104. As illustrated in FIG. 1, the multi-stage noise suppression system 104 can include a primary noise suppressor 106 and a secondary noise suppressor 108. In the exemplary embodiment illustrated in FIG. 1, the primary noise suppressor 106 can shape the high-velocity, high-volume input stream of gas 154 as the high-velocity, high-volume input stream of gas 154 propagates through the primary noise suppressor 106 to provide a high-velocity, high-volume stream of gas 160. In some embodiments, the primary noise suppressor 106 can be implemented using one or more rigid materials, such as one or more metals, one or more plastic materials, one or more resin materials, one or more composite materials, one or more ceramic materials, and/or one or more fiberglass materials, among others, to provide some examples, to provide a rigid, or fixed, primary noise suppressor and/or one or more non-rigid, flexible materials, such as one or more carbon fiber materials, one or more aramid fiber materials, one or more polyester resin materials, one or more thermoplastic composite materials, and/or one or more cellulose fiber materials, among others, to provide some examples, to provide a moveable, or adjustable, primary noise suppressor. Other features, structures, characteristics, or the like for the primary noise suppressor 106 are further described in U.S. patent application Ser. No. 16/997,511, filed on Aug. 19, 2020, now U.S. Pat. No. 11,260,314, U.S. patent application Ser. No. 17/150,794, filed on Jan. 15, 2021, now U.S. Pat. No. 11,986,849, and/or U.S. patent application Ser. No. 18/439,004, filed on Feb. 12, 2024, each of which is incorporated herein by reference in its entirety.

As illustrated in FIG. 1, the high-velocity, high-volume input stream of gas 154 can generate an unwanted noise 158 as the high-velocity, high-volume input stream of gas 154 propagates through the primary noise suppressor 106. In some embodiments, the high-velocity, high-volume input stream of gas 154 can propagate along one or more surfaces of the primary noise suppressor 106 as the high-velocity, high-volume input stream of gas 154 propagates through the primary noise suppressor 106. In these embodiments, the high-velocity, high-volume input stream of gas 154 can generate the unwanted noise 158 as the high-velocity, high-volume input stream of gas 154 propagates along the one or more surfaces of the primary noise suppressor 106. Alternatively, or in addition to, the high-velocity, high-volume input stream of gas 154 can generate the unwanted noise 158 as the high-velocity, high-volume input stream of gas 154 interacts with the surrounding environment, for example, surrounding ambient air, as the high-velocity, high-volume input stream of gas 154 exits the primary noise suppressor 106. In some embodiments, the air amplification system 100 can be used to provide one or more atmospheric effects relating to an event, such a musical event, a theatrical event, a sporting event, a motion picture, and/or any other suitable event that will be apparent to those skilled in the relevant art(s) without departing the spirit and scope of the present disclosure, as described in U.S. patent application Ser. No. 16/997,511, filed on Aug. 19, 2020, now U.S. Pat. No. 11,260,314, and U.S. patent application Ser. No. 16/997,518, filed on Aug. 19, 2020, now U.S. Pat. No. 11,266,921, each of which is incorporated herein by reference in its entirety. In these embodiments, the unwanted noise 158 generated by the high-velocity, high-volume input stream of gas 154 can be characterized being within a frequency range, for example, an audible frequency range, such as between approximately 20 Hz and approximately 20 kHz, which can diminish the experience of the audience observing the event. As an example, the unwanted noise 158 generated by the high-velocity, high-volume input stream of gas 154 can be characterized as being a whoosh, or whoosh-like, sound within the audible frequency range which can propagate, unless suppressed, to the audience as the audience is observing the event. In this example, this whoosh, or whoosh-like, sound can diminish the actual audible content of the event to diminish the experience of the audience observing the event. In the exemplary embodiment illustrated in FIG. 1, the primary noise suppressor 106 can advantageously suppress, for example, diminish, re-tune, and/or even completely cancel, the unwanted noise 158 generated by the high-velocity, high-volume input stream of gas 154. In some embodiments, at least some of the unwanted noise 158 generated by the high-velocity, high-volume input stream of gas 154 exits, the primary noise suppressor 106 to create an unwanted noise 162. In some embodiments, the unwanted noise 162 can be characterized as being at a minimum in a parallel direction to the primary noise suppressor 106. In these embodiments, the unwanted noise 162 can be characterized as increasing when traversing from the parallel direction to a perpendicular, or normal, direction to the primary noise suppressor 106. For example, the unwanted noise 162 at approximately thirty (30) degrees from the parallel direction is less than the unwanted noise 162 at approximately sixty (60) degrees from the parallel direction.

In the exemplary embodiment illustrated in FIG. 1, the secondary noise suppressor 108 can shape the high-velocity, high-volume stream of gas 160 as the high-velocity, high-volume stream of gas 160 propagates through the secondary noise suppressor 108 to provide the high-velocity, high-volume output stream of gas 156. In some embodiments, the secondary noise suppressor 108 can suppress, for example, diminish, re-tune, and/or even completely cancel, the unwanted noise 162. In some embodiments, the secondary noise suppressor 108 can be implemented using one or more rigid materials, such as one or more metals, one or more plastic materials, one or more resin materials, one or more composite materials, one or more ceramic materials, and/or one or more fiberglass materials, among others, to provide some examples, and/or one or more non-rigid, flexible materials, such as one or more carbon fiber materials, one or more aramid fiber materials, one or more polyester resin materials, one or more thermoplastic composite materials, and/or one or more cellulose fiber materials, among others, to provide some examples, among others.

In the exemplary embodiment illustrated in FIG. 1, the secondary noise suppressor 108 can advantageously suppress, for example, diminish, re-tune, and/or even completely cancel, the unwanted noise 162. As illustrated in FIG. 1, the secondary noise suppressor 108 directs the high-velocity, high-volume stream of gas 160 through the secondary noise suppressor 108. As the high-velocity, high-volume stream of gas 160 propagates through the secondary noise suppressor 108, the velocity of the high-velocity, high-volume stream of gas 160 increases, which, according to Bernoulli's principle, causes the pressure to decrease within the secondary noise suppressor 108 to form a lower pressure zone. The lower pressure zone within the secondary noise suppressor 108 causes a low-velocity input stream of gas 164, for example, ambient air, to be drawn into the secondary noise suppressor 108. The low-velocity input stream of gas 164 thereafter mixes, combines, diffuses, or the like with the unwanted noise 162 to suppress, for example, diminish, re-tune, and/or even completely cancel, the unwanted noise 162. In some embodiments, the mixing, combining, diffusing, or the like of the unwanted noise 162 and the low-velocity input stream of gas 164 can, for example, decrease the velocity of the unwanted noise 162, reduce pressure fluctuations within the secondary noise suppressor 108, diffuse and/or dissipate sound energy within the secondary noise suppressor 108 which can suppress, for example, diminish, re-tune, and/or even completely cancel, the unwanted noise 162.

Moreover, the secondary noise suppressor 108 can include one or more acoustic absorption chambers to further suppress the unwanted noise 162. In some embodiments, the secondary noise suppressor 108 can include one or more passive acoustic absorption chambers to passively suppress the unwanted noise 162. In these embodiments, the one or more passive acoustic absorption chambers can include one or more absorption materials to passively suppress the unwanted noise 162. The one or more absorption materials can include one or more acoustic foams, also referred to as studio foams; one or more sound insulations, such as mineral wool, rock wool, and/or fiberglass to provide some examples; one or more acoustic fabrics; one or more acoustic coatings, such as Mass Loaded Vinyl (MLV) to provide an example; one or more acoustic paints; and/or any other suitable material that is capable of absorbing the unwanted noise 162 that will be apparent to those skilled in the relevant art(s) without departing the spirit and scope of the present disclosure. Alternatively, or in addition to, the secondary noise suppressor 108 can include one or more active acoustic suppression chambers to actively suppress the unwanted noise 162. In some embodiments, the high-velocity, high-volume stream of gas 160 and/or the unwanted noise 162 can cause the one or more active acoustic suppression chambers to resonate by, for example, Helmholtz resonance, to generate one or more noise suppression waves. In these embodiments, the one or more noise suppression waves can destructively combine with the unwanted noise 162 to suppress the unwanted noise 162.

Exemplary Secondary Noise Suppressors that can be Implemented within the Exemplary Air Amplifier with Multi-Stage Noise Suppression System

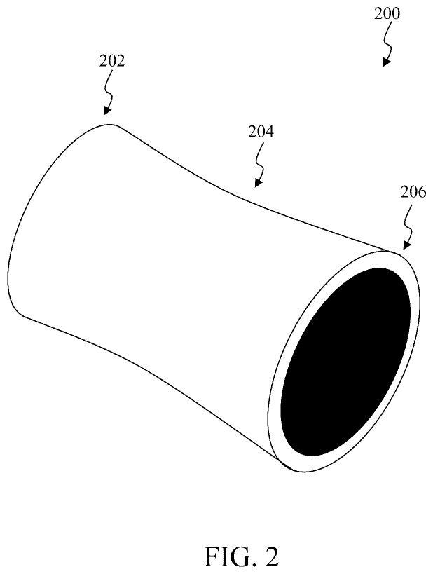

FIG. 2 graphically illustrates a first exemplary secondary noise suppressor that can be implemented within the exemplary air amplifier with multi-stage noise suppression system in accordance with some exemplary embodiments. In the exemplary embodiment illustrated in FIG. 2, a secondary noise suppressor 200 can be characterized as being one or more three-dimensional shapes, for example, cubes, spheres, cylinders, pyramids, and/or cones, among others, including one or more three-dimensional volumes, or hollow cavities, for propagating and/or shaping the high-velocity, high-volume stream of gas 160 as the high-velocity, high-volume stream of gas 160 propagates through the secondary noise suppressor 200. The secondary noise suppressor 200 can represent an exemplary embodiment of the secondary noise suppressor 108 as described herein.

As illustrated in FIG. 2, the secondary noise suppressor 200 can include an air inflow 202 to receive the high-velocity, high-volume stream of gas 160 and/or the unwanted noise 162 from the primary noise suppressor 106, an air duct 204 to shape the high-velocity, high-volume stream of gas 160 and/or to suppress, for example, diminish, re-tune, and/or even completely cancel, the unwanted noise 162, and an air outflow 206 to further shape the high-velocity, high-volume stream of gas 160 to provide the provide the high-velocity, high-volume output stream of gas 156. Generally, the air inflow 202 can be implemented using a regular closed geometric opening that is compatible with the primary noise suppressor 106 and the air outflow 206 can be implemented using a regular closed geometric opening to further shape the high-velocity, high-volume stream of gas 160 as the high-velocity, high-volume stream of gas 160 is exiting the secondary noise suppressor 200. In the exemplary embodiment illustrated in FIG. 2, the secondary noise suppressor 200 can be implemented using circular openings at the air inflow 202 and the air outflow 206. In this exemplary embodiment, a diameter of the circular opening at the air inflow 202 is less than a diameter of the circular opening at the air outflow 206 such that the air duct 204 approximates a tapered conical cylinder. However, those skilled in the relevant art(s) will recognize that the air inflow 202 and/or the air outflow 206 can be implemented using other regular closed geometric structures, irregular closed structures, such as one or more irregular polygons to provide an example, and/or any suitable combination of closed structures that will be apparent to those skilled in the relevant art(s) without departing from the spirit and scope of the present disclosure. As illustrated in FIG. 2, the air duct 204 can be gradually tapered to provide an exponential decrease of its cross-sectional area and/or an exponential decrease of its cross-sectional area to form a conical horn shape. As the high-velocity, high-volume stream of gas 160 propagates through the air duct 204, the high-velocity, high-volume stream of gas 160 follows this horn shape which can shape the high-velocity, high-volume stream of gas 160 to provide a truncated cone as the high-velocity, high-volume output stream of gas 156. However, those skilled in the relevant art(s) will recognize that the air duct 204 can be implemented using other configurations and arrangements to shape the high-velocity, high-volume stream of gas 160 differently to provide other can shape for the high-velocity, high-volume output stream of gas 156 without departing from the spirit and scope of the present disclosure.

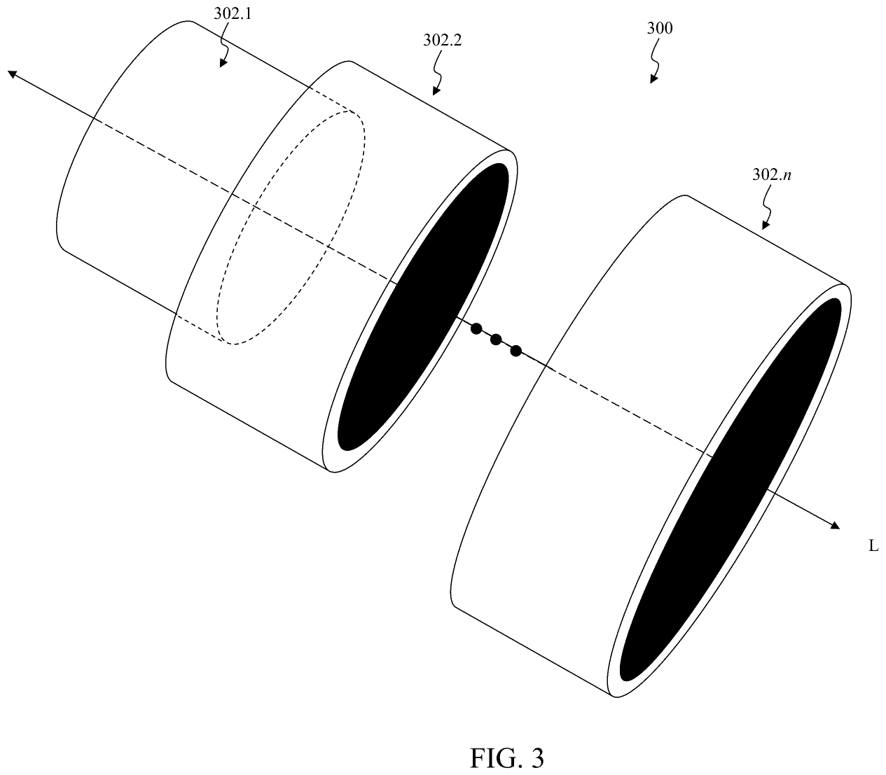

FIG. 3 graphically illustrates a second exemplary secondary noise suppressor that can be implemented within the exemplary air amplifier with multi-stage noise suppression system in accordance with some exemplary embodiments. In the exemplary embodiment illustrated in FIG. 3, a multi-stage secondary noise suppressor 300 can be characterized as being one or more three-dimensional shapes, for example, cubes, spheres, cylinders, pyramids, and/or cones, among others, including one or more three-dimensional volumes, or hollow cavities, for propagating and/or shaping the high-velocity, high-volume stream of gas 160 as the high-velocity, high-volume stream of gas 160 propagates through the multi-stage secondary noise suppressor 300. The multi-stage secondary noise suppressor 300 can represent an exemplary embodiment of the secondary noise suppressor 108 as described herein.

As illustrated in FIG. 3, the multi-stage secondary noise suppressor 300 can include secondary noise suppressors 302.1 through 302.n. In some embodiments, the secondary noise suppressors 302.1 through 302.n can be constructed, created, manufactured, fabricated, or the like to have substantially similar three-dimensional shapes as one another. Alternatively, or in addition to, two or more of the secondary noise suppressors 302.1 through 302.n can be constructed, created, manufactured, fabricated, or the like to have different three-dimensional shapes from one another. Moreover, in the exemplary embodiment illustrated in FIG. 3, the secondary noise suppressors 302.1 through 302.n can be configured and arranged to be aligned along, for example, parallel to, a longitudinal axis L of the multi-stage secondary noise suppressor 300. Generally, the longitudinal axis L of the multi-stage secondary noise suppressor 300 represents an imaginary line that is parallel to the multi-stage secondary noise suppressor 300. As illustrated in FIG. 3, the longitudinal axis L of the multi-stage secondary noise suppressor 300 can extend through the approximate center of the multi-stage secondary noise suppressor 300 to form a central axis of the multi-stage secondary noise suppressor 300. In some embodiments, the secondary noise suppressors 302.1 through 302.n can be configured and arranged to be centered with respect to one another about the central axis of the multi-stage secondary noise suppressor 300. Alternatively, or in addition to, one or more of the secondary noise suppressors 302.1 through 302.n can be configured and arranged to be offset with respect to one another about the central axis of the multi-stage secondary noise suppressor 300. In some embodiments, the secondary noise suppressors 302.1 through 302.n can be partially situated within, or partially overlap, one another. In these embodiments, the secondary noise suppressors 302.1 through 302.n can be configured and arranged to be partially overlapping coaxial assemblies, mechanisms, units, structures, or the like that share the central axis of the multi-stage secondary noise suppressor 300 but do not fully align along their corresponding lengths resulting in corresponding portions of the secondary noise suppressors 302.1 through 302.n overlapping one another.

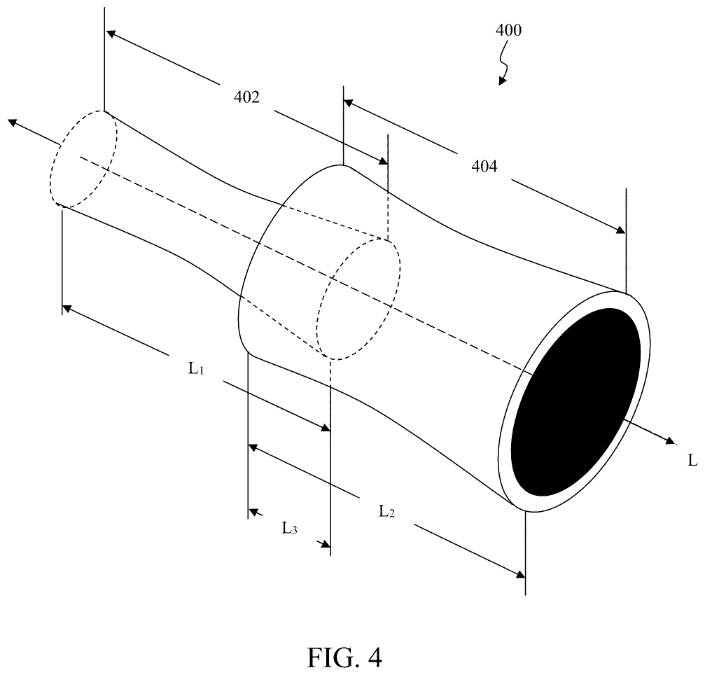

FIG. 4 graphically illustrates an exemplary multi-stage noise suppression system that can be implemented within the exemplary air amplifier with multi-stage noise suppression system in accordance with some exemplary embodiments. In the exemplary embodiment illustrated in FIG. 4, a multi-stage noise suppression system 400 can be characterized as being one or more three-dimensional shapes, for example, cubes, spheres, cylinders, pyramids, and/or cones, among others, including one or more three-dimensional volumes, or hollow cavities, for propagating and/or shaping the high-velocity, high-volume input stream of gas 154 as the high-velocity, high-volume input stream of gas 154 propagates through the multi-stage noise suppression system 400. As illustrated in FIG. 4, the multi-stage noise suppression system 400 can include a primary noise suppressor 402 and a secondary noise suppressor 404. In some embodiments, the multi-stage noise suppression system 400, the primary noise suppressor 402, and/or the secondary noise suppressor 404 can represent exemplary embodiment of the multi-stage noise suppression system 104, the primary noise suppressor 106, and/or the secondary noise suppressor 108, respectively, as described herein.

As illustrated in FIG. 4, the primary noise suppressor 402 can be mechanically connected to the secondary noise suppressor 404. In some embodiments, the primary noise suppressor 402 and the secondary noise suppressor 404 can be constructed, created, manufactured, fabricated, or the like to be discrete, individual components for the multi-stage noise suppression system 400. In these embodiments, these discrete, individual components can be mechanically connected to one another with various fasteners, such as nuts, screws, bolts, rivets, pins, and/or lags to provide some examples. Alternatively, or in addition to, the primary noise suppressor 106 and the secondary noise suppressor 108 can constructed, created, manufactured, fabricated, or the like to be combined to form an integrated assembly, mechanism, unit, structure, or the like for the multi-stage noise suppression system 400 in which the primary noise suppressor 106 and the secondary noise suppressor 108 function substantially similar in the integrated assembly, mechanism, unit, structure, or the like as they would individually. In some embodiments, the primary noise suppressor 106 and the secondary noise suppressor 108 can be three-dimensional (3D) printed to form the multi-stage noise suppression system 400 using, for example, one or more metals, one or more plastic materials, one or more resin materials, one or more composite materials, and/or one or more ceramic materials, among others.

In the exemplary embodiment illustrated in FIG. 4, the primary noise suppressor 402 and the secondary noise suppressor 404 can be configured and arranged to be aligned along, for example, parallel to, a longitudinal axis L of the multi-stage noise suppression system 400. Generally, the longitudinal axis L of the multi-stage noise suppression system 400 represents an imaginary line that is parallel to the multi-stage noise suppression system 400. As illustrated in FIG. 4, the longitudinal axis L of the multi-stage noise suppression system 400 can extend through the approximate center of the multi-stage noise suppression system 400 to form a central axis of the multi-stage noise suppression system 400. In some embodiments, the primary noise suppressor 402 and the secondary noise suppressor 404 can be configured and arranged to be centered with respect to one another about the central axis of the multi-stage noise suppression system 400. Alternatively, the primary noise suppressor 402 and the secondary noise suppressor 404 can be configured and arranged to be offset with respect to one another about the central axis of the multi-stage noise suppression system 400. In some embodiments, the primary noise suppressor 402 can be partially situated within, or partially overlap, the secondary noise suppressor 404 about the central axis of the multi-stage noise suppression system 400. In these embodiments, the primary noise suppressor 402 and the secondary noise suppressor 404 can be configured and arranged to be partially overlapping coaxial assemblies, mechanisms, units, structures, or the like that share the central axis of the multi-stage noise suppression system 400 but do not fully align along their corresponding lengths resulting in a corresponding portion of the primary noise suppressor 402 overlapping a corresponding portion of the secondary noise suppressor 404. As illustrated in FIG. 4, the primary noise suppressor 402 can be characterized as having a first length L₁ along the central axis of the multi-stage noise suppression system 400 and the secondary noise suppressor 404 can be characterized as having a second length L₂ along the central axis of the multi-stage noise suppression system 400. In some embodiments, the primary noise suppressor 402 can partially overlap the secondary noise suppressor 404 by a third length L₃ along the central axis of the multi-stage noise suppression system 400. In these embodiments, the third length L₃ can be approximately one-third the overall length of the multi-stage noise suppression system 400. For example, the first length L₁ can be approximately eight (8) inches, the second length L₂ can be approximately eight (8), and the third length L₃ can be approximately four (4) inches.

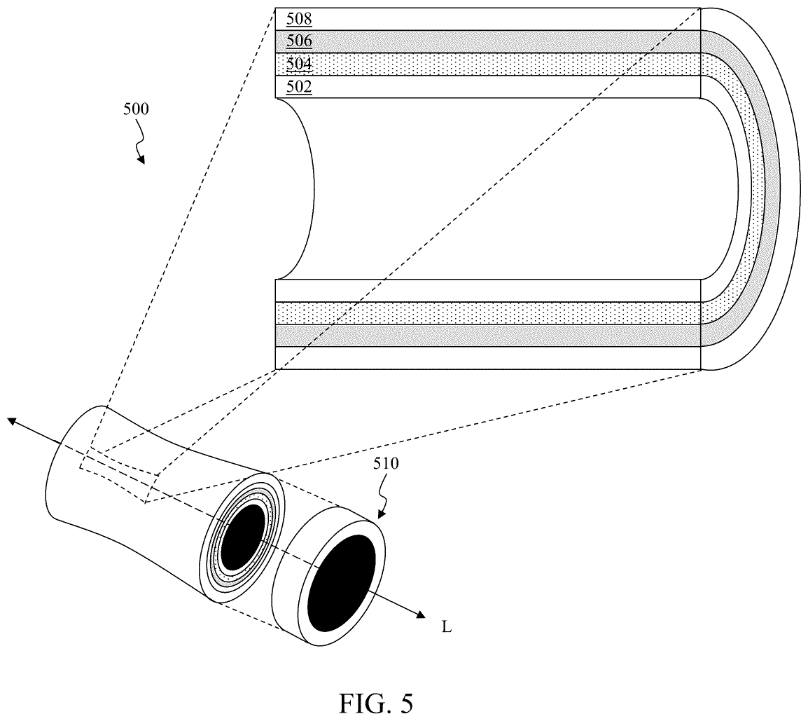

FIG. 5 graphically illustrates a third exemplary secondary noise suppressor that can be implemented within the exemplary air amplifier with multi-stage noise suppression system in accordance with some exemplary embodiments. In the exemplary embodiment illustrated in FIG. 5, a secondary noise suppressor 500 can be coupled, for example, mechanically connected, to a primary noise suppressor, such as the primary noise suppressor 106 as described herein. In some embodiments, the primary noise suppressor can shape the high-velocity, high-volume input stream of gas 154 as the high-velocity, high-volume input stream of gas 154 propagates through the primary noise suppressor 106 to provide the high-velocity, high-volume stream of gas 160 and/or the unwanted noise 162 to the secondary noise suppressor 500 in a substantially similar manner as described herein. In the exemplary embodiment illustrated in FIG. 5, the secondary noise suppressor 500 can shape the high-velocity, high-volume stream of gas 160 as the high-velocity, high-volume stream of gas 160 propagates through the secondary noise suppressor 500 to provide the high-velocity, high-volume output stream of gas 156 as described herein. In some embodiments, the secondary noise suppressor 500 can suppress, for example, diminish, re-tune, and/or even completely cancel, the unwanted noise 162. In these embodiments, the secondary noise suppressor 500 can be characterized as passively suppressing and/or actively suppressing for example, diminishing, re-tuning, or even completely cancelling, the unwanted noise 162.

As illustrated in FIG. 5, the secondary noise suppressor 500 can include a first inner faceplate 502, a passive acoustic absorption chamber 504, an active acoustic suppression chamber 804, and a second outer faceplate 508. In the exemplary embodiment illustrated in FIG. 5, the first inner faceplate 502 forms an innermost assembly of the secondary noise suppressor 500. In the exemplary embodiment illustrated in FIG. 5, the secondary noise suppressor 500 can be characterized as having one or more three-dimensional volumes, or hollow cavities, along the longitudinal axis L for propagating and/or shaping the high-velocity, high-volume stream of gas 160 as the high-velocity, high-volume stream of gas 160 propagates through the secondary noise suppressor 500. In these embodiments, the first inner faceplate 502 can be situated within, for example, along one or more surfaces of, the one or more hollow cavities along the longitudinal axis L and/or any portions thereof. In the exemplary embodiment illustrated in FIG. 5, the first inner faceplate 502 can have a uniform cross-sectional area along the longitudinal axis L of the secondary noise suppressor 500. In some embodiments, the first inner faceplate 502 can be characterized as being a cylindrical, or a cylindrical-like, shell that is situated within the one or more hollow cavities. Alternatively, or in addition to, the first inner faceplate 502 can have a non-uniform cross-sectional area along the longitudinal axis L of the secondary noise suppressor 500. In some embodiments, the first inner faceplate 502 can be characterized as being gradually thinned or narrowed towards an air inflow, such as the air inflow 202, and/or an air outflow, such as the air outflow 206, also referred to as being tapered, along the longitudinal axis L.

As illustrated in FIG. 5, the first inner faceplate 502 can shape the high-velocity, high-volume stream of gas 160 as the high-velocity, high-volume stream of gas 160 propagates through the secondary noise suppressor 500. In some embodiments, the first inner faceplate 502 can be implemented as a three-dimensional shape, such as a cube, a rectangular prism, a sphere, a cone, a cylinder, and/or any other suitable three-dimensional shape that will be apparent to those skilled in the relevant art(s) without departing from the spirit and scope of the present disclosure to provide some examples, having the one or more hollow cavities along the longitudinal axis L. In the exemplary embodiment illustrated in FIG. 5, the high-velocity, high-volume stream of gas 160 and the unwanted noise 162 traverse within the first inner faceplate 502. As illustrated in FIG. 5, the high-velocity, high-volume stream of gas 160 and/or the unwanted noise 162 can propagate through the first inner faceplate 502 onto the passive acoustic absorption chamber 504. In some embodiments, the first inner faceplate 502 can be implemented using one or more rigid materials, such as one or more metals, one or more plastic materials, one or more resin materials, one or more composite materials, one or more ceramic materials, and/or one or more fiberglass materials, among others, to provide some examples, and/or one or more non-rigid, flexible materials, such as one or more carbon fiber materials, one or more aramid fiber materials, one or more polyester resin materials, one or more thermoplastic composite materials, and/or one or more cellulose fiber materials, among others, to provide some examples, among others. In some embodiments, the first inner faceplate 502 can include one or more perforations to allow the high-velocity, high-volume stream of gas 160 and/or the unwanted noise 162 to propagate through the first inner faceplate 502 onto the passive acoustic absorption chamber 504. In these embodiments, the one or more perforations can be implemented using one or more regular closed geometric openings, such as ellipses, hexagons, and/or diamonds to provide some examples, within the first inner faceplate 502 that are free of the one or more rigid materials and/or the one or more non-rigid, flexible materials. However, those skilled in the relevant art(s) will recognize that the one or more perforations can be implemented using other regular closed geometric structures, irregular closed structures, such as one or more irregular polygons to provide an example, and/or any suitable combination of closed structures that will be apparent to those skilled in the relevant art(s) without departing from the spirit and scope of the present disclosure. In some embodiments, the one or more perforations can be substantially similar to one another throughout the first inner faceplate 502, differ from one another throughout the first inner faceplate 502, and/or any combination thereof. In some embodiments, one or more regions of the first inner faceplate 502 can have substantially similar perforations that differ from perforations in other regions of the first inner faceplate 502.

In the exemplary embodiment illustrated in FIG. 5, the passive acoustic absorption chamber 504 can passively suppress, namely, absorb, the unwanted noise 162 propagating through the first inner faceplate 502. As illustrated in FIG. 5, the high-velocity, high-volume stream of gas 160 and/or the unwanted noise 162 can collide with the first inner faceplate 502 as the high-velocity, high-volume stream of gas 160 and/or the unwanted noise 162 propagates through the secondary noise suppressor 500. Each collision between the high-velocity, high-volume stream of gas 160 and/or the unwanted noise 162 and the first inner faceplate 502 can cause some of the high-velocity, high-volume stream of gas 160 and/or the unwanted noise 162 to propagate through the first inner faceplate 502 onto the passive acoustic absorption chamber 504. Thereafter, some of the unwanted noise 162 that propagates through the first inner faceplate 502 can be suppressed, namely, absorbed, by the passive acoustic absorption chamber 504 and/or some of the high-velocity, high-volume stream of gas 160 and/or the unwanted noise 162 that propagates through the first inner faceplate 502 can continue to propagate through the passive acoustic absorption chamber 504 onto the active acoustic suppression chamber 804. In some embodiments, the passive acoustic absorption chamber 504 can transfer the kinetic energy of the high-velocity, high-volume stream of gas 160 and/or the unwanted noise 162 into heat energy to suppress the unwanted noise 162. In some embodiments, the amount of the high-velocity, high-volume stream of gas 160 and/or the unwanted noise 162 that is absorbed by the passive acoustic absorption chamber 504 can be related to one or more acoustic impedances of the passive acoustic absorption chamber 504, wavelengths of the high-velocity, high-volume stream of gas 160 and/or the unwanted noise 162, and/or an incident angle between the high-velocity, high-volume stream of gas 160 and/or the unwanted noise 162 and the first inner faceplate 502. In some embodiments, the passive acoustic absorption chamber 504 can include one or more porous sound absorption materials such as acoustic foams, also referred to as studio foams; one or more sound insulations, such as mineral wool, rock wool, and/or fiberglass to provide some examples; one or more acoustic fabrics; one or more acoustic coatings, such as Mass Loaded Vinyl (MLV) to provide an example; one or more acoustic paints; and/or any other suitable material that is capable of absorbing the high-velocity, high-volume stream of gas 160 and/or the unwanted noise 162 propagating through the passive acoustic absorption chamber 504.

As illustrated in FIG. 5, the active acoustic suppression chamber 506 can be situated within the secondary noise suppressor 500 between the passive acoustic absorption chamber 504 and the second outer faceplate 508. In the exemplary embodiment illustrated in FIG. 5, the active acoustic suppression chamber 506 can actively suppress the unwanted noise 162 that propagates through the passive acoustic absorption chamber 504. As illustrated in FIG. 5, some of the high-velocity, high-volume stream of gas 160 and/or the unwanted noise 162 can propagate through the passive acoustic absorption chamber 504 onto the active acoustic suppression chamber 506. Thereafter, the high-velocity, high-volume stream of gas 160 and/or the unwanted noise 162 that propagates through the passive acoustic absorption chamber 504 can cause the active acoustic suppression chamber 506 to resonate by, for example, Helmholtz resonance, to generate multiple noise suppression waves 850. In some embodiments, the active acoustic suppression chamber 506 can be effectively tuned to resonate at one or more resonant frequencies. In these embodiments, the high-velocity, high-volume stream of gas 160 and/or the unwanted noise 162 that propagates through the passive acoustic absorption chamber 504 can cause the ambient air within the active acoustic suppression chamber 506 to vibrate at the one or more resonant frequencies to generate the multiple noise suppression waves 850 at these resonant frequencies. In some embodiments, the multiple noise suppression waves 850 can destructively combine with the high-velocity, high-volume stream of gas 160 and/or the unwanted noise 162 that propagates through the passive acoustic absorption chamber 504 to suppress the unwanted noise 162 that propagates through the passive acoustic absorption chamber 504.

In the exemplary embodiment illustrated in FIG. 5, the second outer faceplate 508 forms an outermost assembly of the secondary noise suppressor 500. As described above, the secondary noise suppressor 500 can be characterized as having one or more three-dimensional volumes, or hollow cavities, along the longitudinal axis L. In some embodiments, the second outer faceplate 508 can be situated along the longitudinal axis L. In other embodiments, the three-dimensional shape of the second outer faceplate 508 can be different from the three-dimensional shape of the first inner faceplate 502. In some embodiments, the second outer faceplate 508 can be implemented as a three-dimensional shape, such as a cube, a rectangular prism, a sphere, a cone, a cylinder, and/or any other suitable three-dimensional shape that will be apparent to those skilled in the relevant art(s) without departing from the spirit and scope of the present disclosure to provide some examples having one or more hollow cavities. In some embodiments the three-dimensional shape of the second outer faceplate 508 can be substantially similar to the three-dimensional shape of the first inner faceplate 502. Moreover, as described herein, some of the high-velocity, high-volume stream of gas 160 and/or the unwanted noise 162 that propagates through the passive acoustic absorption chamber 504 can propagate through the active acoustic suppression chamber 506 onto the second outer faceplate 508. In some embodiments, the active acoustic suppression chamber 506 can include one or more hollow cavities. In these embodiments, the second outer faceplate 508 can reflect the high-velocity, high-volume stream of gas 160 and/or the unwanted noise 162 that propagates through the active acoustic suppression chamber 506 back onto the passive acoustic absorption chamber 504. In these embodiments, the second outer faceplate 508 can be implemented using one or more acoustically reflective materials, such as the one or more rigid materials and/or one or more non-rigid, flexible materials, among others. In some embodiments, the second outer faceplate 508 can be implemented using sufficiently dense materials from among the acoustically reflective materials which can prevent the second outer faceplate 508 from resonating as the high-velocity, high-volume stream of gas 160 and/or the unwanted noise 162 propagates through the secondary noise suppressor 500.

In the exemplary embodiment illustrated in FIG. 5, the secondary noise suppressor 500 can optionally include an endcap 510 to secure the first inner faceplate 502, the passive acoustic absorption chamber 504, the active acoustic suppression chamber 506 and the second outer faceplate 508 within the secondary noise suppressor 500 as the high-velocity, high-volume stream of gas 160 propagates through the secondary noise suppressor 500. As illustrated in FIG. 5, the endcap 510 can be implemented 210 as one or more cylindrical shapes having one or more three-dimensional volumes, or hollow cavities, of one or more truncated cones formed therein. However, those skilled in the relevant art(s) will recognize that the endcap 510 and/or the one or more hollow cavities formed therein can be implemented using other three-dimensional shapes, such as cubes, rectangular prisms, cylinders, and/or spheres to provide some examples, without departing from the spirit and scope of the present disclosure. In some embodiments, the endcap 510 can be configured and arranged to be mechanically connected to the second outer faceplate 508 with various fasteners, such as nuts, screws, bolts, rivets, pins, and/or lags to provide some examples. In some embodiments, a cross-sectional area of the endcap 510 is greater than a cross-sectional area of the second outer faceplate 508 at an air outflow, such as the air outflow 206, of the secondary noise suppressor 500 to allow the endcap 510 to effectively slide over the second outer faceplate 508. In the exemplary embodiment illustrated in FIG. 5, the endcap 510 can include one or more three-dimensional volumes, or hollow cavities, to allow the high-velocity, high-volume stream of gas 160 to exit the secondary noise suppressor 500 to provide the high-velocity, high-volume output stream of gas 156. In some embodiments, one or more cross-sectional areas of the one or more three-dimensional volumes, or hollow cavities, of the endcap 510 are less than or equal to a cross-sectional area of the first inner faceplate 502 at the air outflow to secure the first inner faceplate 502, the passive acoustic absorption chamber 504, the active acoustic suppression chamber 506 and the second outer faceplate 508 within the secondary noise suppressor 500.

Exemplary Inner Faceplates that can Implemented within the Exemplary Secondary Noise Suppressors Described Herein

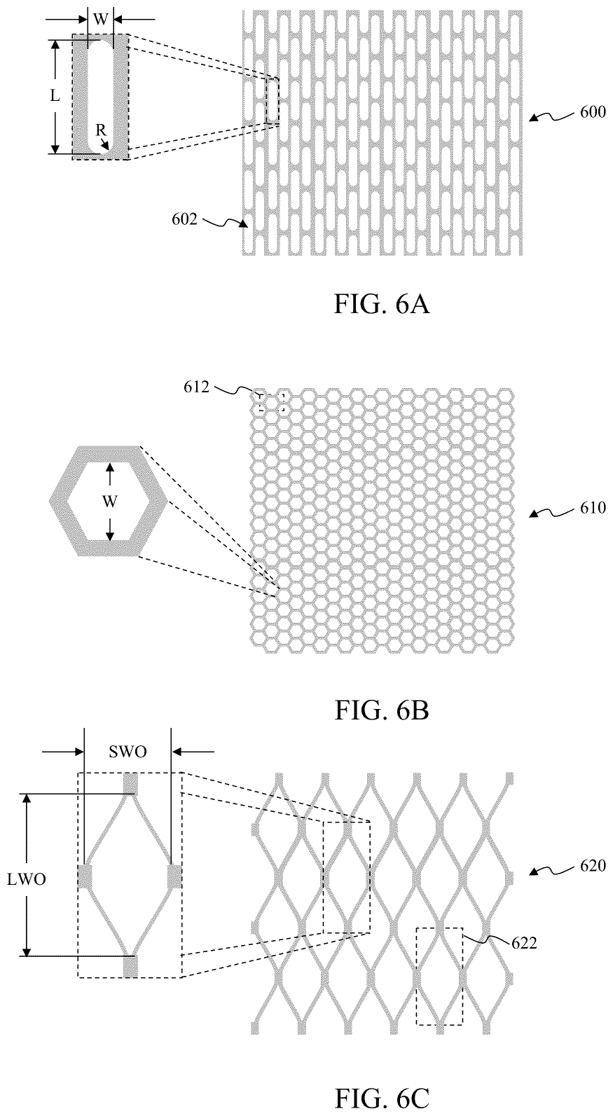

FIG. 6A through FIG. 6C graphically illustrate exemplary inner faceplates that can be implemented within the exemplary secondary noise suppressors described herein in accordance with some exemplary embodiments. As described above in FIG. 2, a first inner faceplate, such as the first inner faceplate 502 to provide an example, can include one or more perforations to allow the high-velocity, high-volume stream of gas 160 and/or the unwanted noise 162 to propagate through the first inner faceplate onto an acoustic absorption chamber, such as the passive acoustic absorption chamber 504 to provide an example. The discussion of FIG. 6A through FIG. 6C to follow is to describe various configurations and arrangements of materials that can be used to implement the first inner faceplate. However, the first inner faceplate is not limited to the materials as described in FIG. 6A through 6C. Those skilled in the relevant art(s) will recognize that other materials having other perforations can be used to implement the first inner faceplate without departing from the spirit and scope of the present disclosure.

As illustrated in FIG. 6A, a slotted sheet material 600 of one or more metallic materials, such as iron, steel, copper, bronze, brass, or aluminum to provide some examples, one or more non-metallic materials, such as wood, plastic, or glass, and/or any combination thereof can be configured and arranged to form the first inner faceplate. In an exemplary embodiment, the slotted sheet material 600 has an approximate thickness of 0.0299 inches, which corresponds to 22 Gauge. In the exemplary embodiment illustrated in FIG. 6A, the sheet material 600 can include one or more elliptical perforations 602 to allow the high-velocity, high-volume stream of gas 160 and/or the unwanted noise 162 to propagate through the first inner faceplate onto the acoustic absorption chamber. In an exemplary embodiment, the slotted sheet material 600 can include approximately 4.76 elliptical perforations 602 per square inch. In some embodiments, the one or more elliptical perforations 602 can be characterized as being in one or more columns and one or more rows to form an array of elliptical perforations. As illustrated in FIG. 6A, the one or more elliptical perforations 602 in each row of elliptical perforations from among the array of elliptical perforations are side staggered from one or more neighboring, adjacent rows of elliptical perforations from among the array of elliptical perforations. Moreover, as illustrated in FIG. 6A, the one or more elliptical perforations 602 can be characterized as having a longitudinal axis L, a width W, and a radius R. In an exemplary embodiment, the longitudinal axis L is approximately 0.75 inches, the width W is approximately 0.125 inches, and the radius R is approximately 0.125 inches.

As illustrated in FIG. 6B, a hexagonal sheet material 310 of the one or more metallic materials, the one or more non-metallic materials and/or any combination thereof can be configured and arranged to form the first inner faceplate. In an exemplary embodiment, the hexagonal sheet material 310 has an approximate thickness of 0.0299 inches, which corresponds to 22 Gauge. In the exemplary embodiment illustrated in FIG. 6B, the hexagonal sheet material 310 can include one or more hexagonal perforations 312 to allow the high-velocity, high-volume stream of gas 160 and/or the unwanted noise 162 to propagate through the first inner faceplate onto the acoustic absorption chamber. In an exemplary embodiment, the hexagonal sheet material 310 can include approximately 16.09 hexagonal perforations 312 per square inch. In some embodiments, the one or more hexagonal perforations 312 can be characterized as being in one or more columns and one or more rows to form an array of hexagonal perforations. As illustrated in FIG. 6B, the one or more hexagonal perforations 312 in each row of hexagonal perforations from among the array of hexagonal perforations are staggered from one or more neighboring, adjacent rows of hexagonal perforations from among the array of hexagonal perforations by, for example, approximately 0.28125 inches center to center at approximately 60 degrees. Moreover, as illustrated in FIG. 6B, the one or more hexagonal perforations 312 can be characterized as having a side-to-side width W. In an exemplary embodiment, the side-to-side width W is approximately 0.25 inches.

As illustrated in FIG. 6C, a diamond sheet material 320 of the one or more metallic materials, the one or more non-metallic materials and/or any combination thereof can be configured and arranged to form the first inner faceplate. In an exemplary embodiment, the diamond sheet material 320 has an approximate thickness of 0.0299 inches, which corresponds to 22 Gauge. In the exemplary embodiment illustrated in FIG. 6B, the diamond sheet material 320 can include one or more diamond perforations 322 to allow the high-velocity, high-volume stream of gas 160 and/or the unwanted noise 162 to propagate through the first inner faceplate onto the acoustic absorption chamber. In an exemplary embodiment, the diamond sheet material 320 can include approximately 9.0 diamond perforations 322 per square foot horizontally, referred to as short way, and approximately 3.8 diamond perforations 322 per square foot vertically, referred to as long way. In some embodiments, the one or more diamond perforations 322 can be characterized as being in one or more columns and one or more rows to form an array of diamond perforations. As illustrated in FIG. 6C, the one or more diamond perforations 322 in each row of diamond perforations from among the array of diamond perforations are staggered from one or more neighboring, adjacent rows of diamond perforations from among the array of diamond perforations. Moreover, as illustrated in FIG. 6C the one or more diamond perforations 322 can be characterized as having a short way of perforation (SWO) and a long way of perforation (LWO). In an exemplary embodiment, the SWO is approximately 1.092 inches and the LWO is approximately 2.750 inches.

Exemplary Acoustic Absorption Chambers that can Implemented within the Exemplary Secondary Noise Suppressors Described Herein

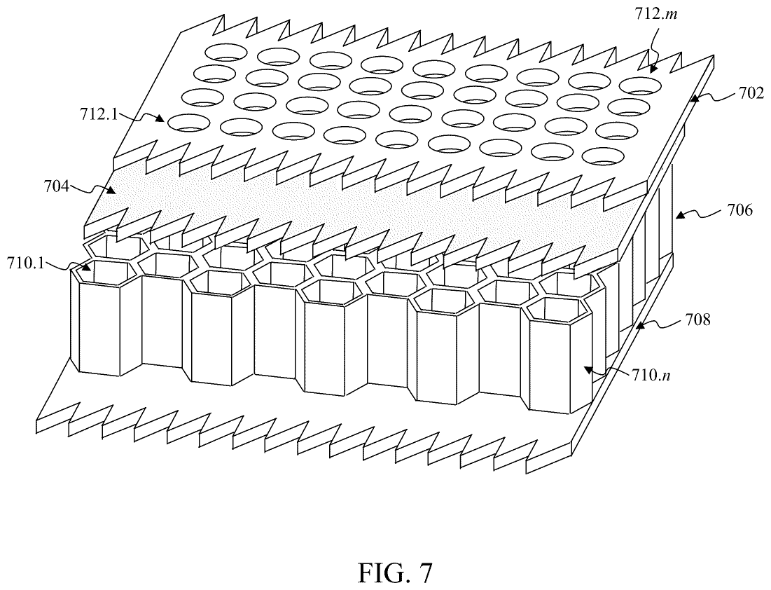

FIG. 7 graphically illustrates various acoustic absorption chambers that can be implemented within the exemplary secondary noise suppressors described herein in accordance with some exemplary embodiments. In the exemplary embodiment illustrated in FIG. 7, an noise suppressor 700 can include a passive acoustic absorption chamber 704 can be situated between a first inner faceplate 702 and an active acoustic suppression chamber 706 that can be situated between the passive acoustic absorption chamber 704 and a second outer faceplate 706. In some embodiments, the first inner faceplate 702, the passive acoustic absorption chamber 704, the active acoustic suppression chamber 706, and the second outer faceplate 708 can be implemented in a substantially similar manner as the inner faceplate 502, the passive acoustic absorption chamber 504, the active acoustic suppression chamber 506, and the second outer faceplate 508, respectively. As described herein, the passive acoustic absorption chamber 704 can passively suppress, namely, absorb, the unwanted noise 162 propagating through an noise suppressor, such as the noise suppressor 700 to provide an example. And as described herein, the active acoustic suppression chamber 704 can use the high-velocity, high-volume stream of gas 160 and/or the unwanted noise 162 that propagates through the passive acoustic absorption chamber 704 to generate multiple noise suppression waves which destructively combine with the unwanted noise 162 that propagates through the passive acoustic absorption chamber 704 to actively suppress the unwanted noise 162 that propagates through the passive acoustic absorption chamber 704.

As illustrated in FIG. 7, the first inner faceplate 702 can include one or more perforations 712.1 through 712.m to allow the high-velocity, high-volume stream of gas 160 and/or the unwanted noise 162 to propagate through the first inner faceplate 702 onto the passive acoustic absorption chamber 704. As illustrated in FIG. 7, the high-velocity, high-volume stream of gas 160 and/or the unwanted noise 162 can collide with the first inner faceplate 702. Each collision between the high-velocity, high-volume stream of gas 160 and/or the unwanted noise 162 and the first inner faceplate 702 can cause some of the high-velocity, high-volume stream of gas 160 and/or the unwanted noise 162 to propagate through the first inner faceplate 702 onto the passive acoustic absorption chamber 704. Thereafter, some of the unwanted noise 162 that propagates through the first inner faceplate 702 can be suppressed, namely, absorbed, by the passive acoustic absorption chamber 704 and/or some of the high-velocity, high-volume stream of gas 160 and/or the unwanted noise 162 that propagates through the first inner faceplate 702 can continue propagate through the passive acoustic absorption chamber 704 onto the acoustic suppression chamber 704. In some embodiments, the passive acoustic absorption chamber 704 can transfer the kinetic energy of the unwanted noise 162 that propagates through the first inner faceplate 702 into heat energy to suppress the unwanted noise 162 in a substantially similar manner as the acoustic absorption chamber 506 as described herein.

In the exemplary embodiment illustrated in FIG. 7, the active acoustic suppression chamber 706 can include acoustic suppression elements 710.1 through 710.n. As illustrated in FIG. 7, the acoustic suppression elements 710.1 through 710.n can be configured and arranged as a series of rows and/or a series of columns to form an array of acoustic suppression elements. In some embodiments, each acoustic suppression element from among the acoustic suppression elements 710.1 through 710.n can be offset, or staggered, from its one or more neighboring, adjacent acoustic suppression elements from among the acoustic suppression elements 710.1 through 710.n to form a two-dimensional lattice of acoustic suppression elements. The two-dimensional lattice can include a rhombic lattice, a square lattice, a rectangular lattice, a parallelogrammical lattice, a triangular lattice, a hexagonal lattice, or any other suitable two-dimensional lattice that will be apparent to those skilled in the relevant art(s) without departing from the spirit and scope of the present disclosure. In some embodiments, the acoustic suppression elements 710.1 through 710.n can be implemented using one or more metals, one or more plastic materials, one or more resin materials, one or more composite materials, one or more ceramic materials, one or more fiberglass materials, one or more carbon fiber materials, one or more aramid fiber materials, one or more polyester resin materials, one or more thermoplastic composite materials, and/or one or more cellulose fiber materials, among others, to provide some examples.

In the exemplary embodiment illustrated in FIG. 7, the acoustic suppression elements 710.1 through 710.n can be effectively tuned to resonate at one or more resonant frequencies in a substantially similar manner as described herein. In some embodiments, the high-velocity, high-volume stream of gas 160 and/or the unwanted noise 162 that propagates through the passive acoustic absorption chamber 704 can cause the acoustic suppression elements 710.1 through 710.n to resonate by, for example, Helmholtz resonance, to generate multiple noise suppression waves in a substantially similar manner as described herein. In the exemplary embodiment illustrated in FIG. 7, the high-velocity, high-volume stream of gas 160 and/or the unwanted noise 162 that propagates through the passive acoustic absorption chamber 704 can cause the ambient air within the acoustic suppression elements 710.1 through 710.n to vibrate at the one or more resonant frequencies to generate the multiple noise suppression waves at these resonant frequencies in a substantially similar manner as described herein.

Exemplary Active Acoustic Suppression Chambers that can be Implemented within the Exemplary Secondary Noise Suppressors Described Herein

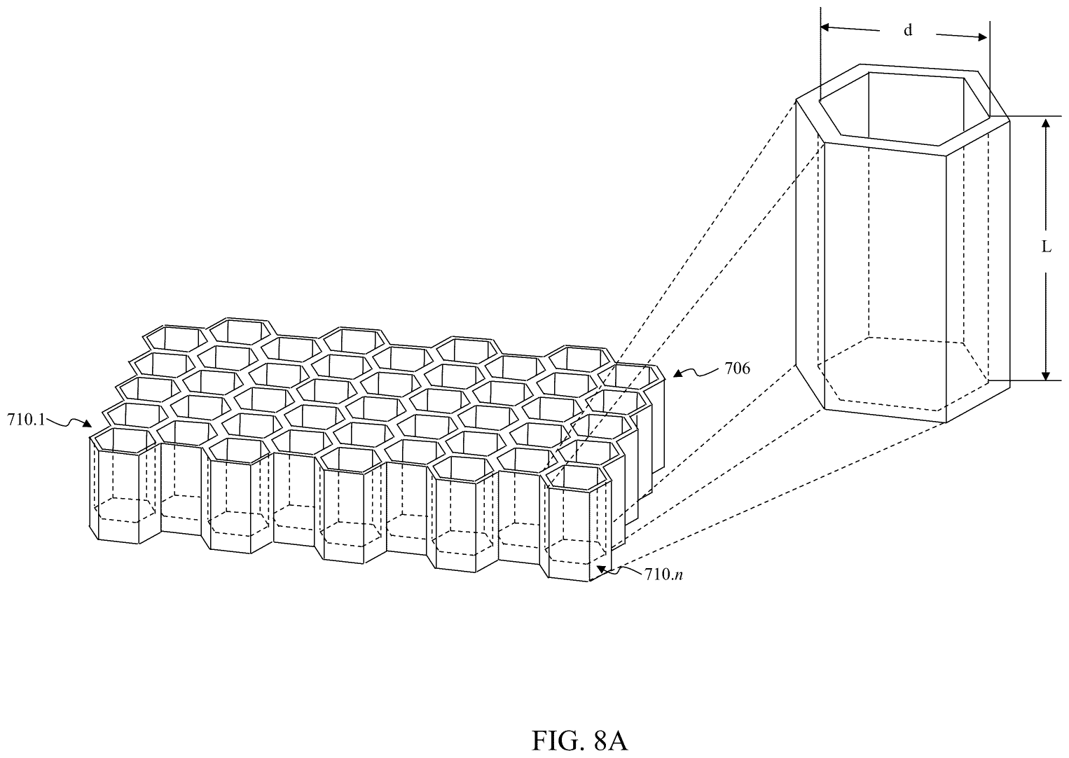

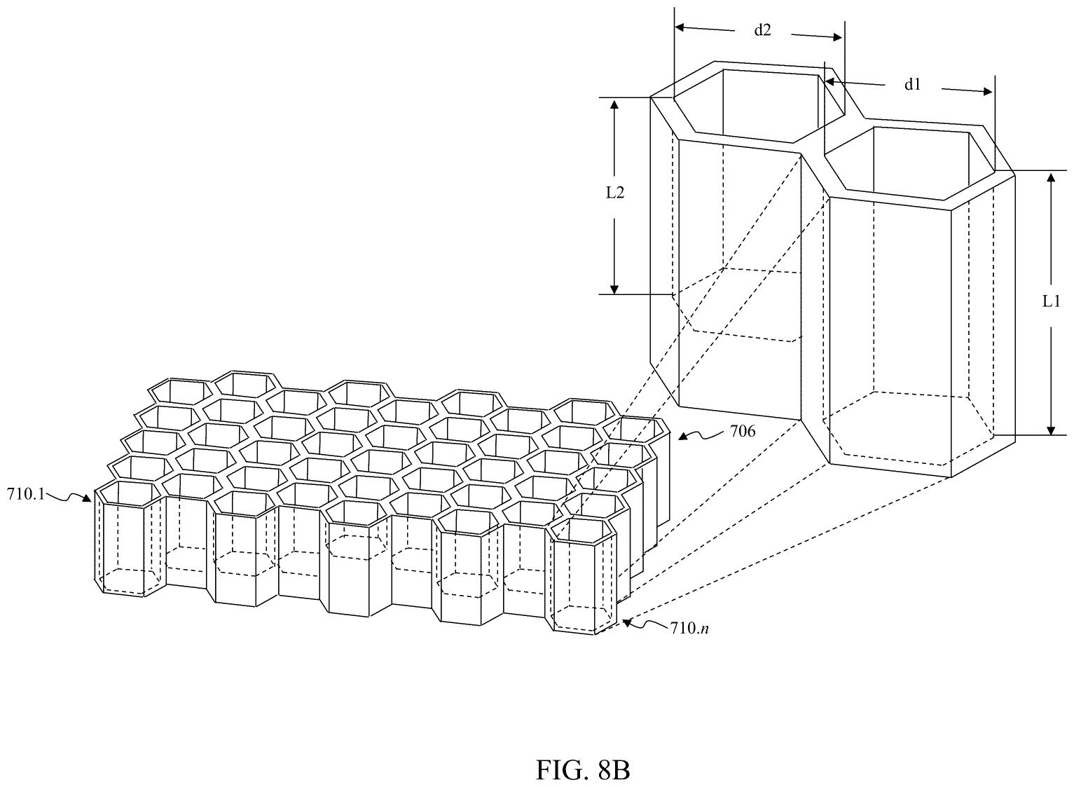

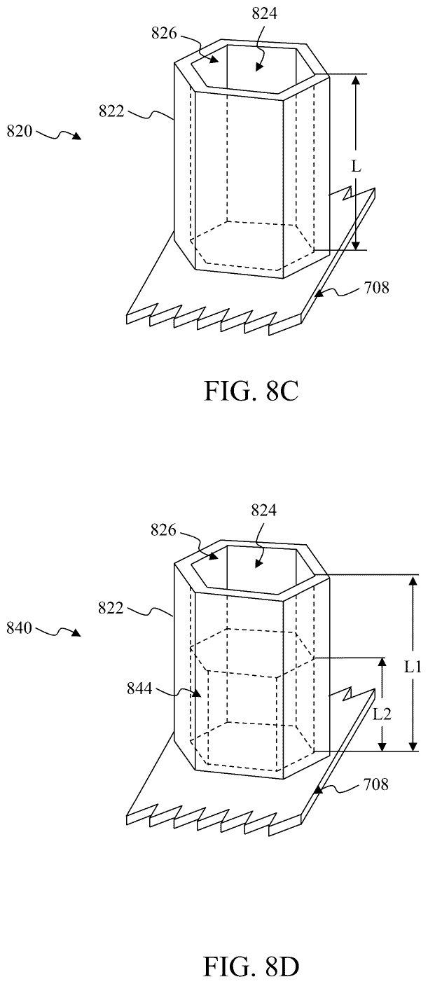

FIG. 8A through FIG. 8D graphically illustrate various exemplary active acoustic suppression chambers that can be implemented within the exemplary secondary noise suppressors described herein in accordance with some exemplary embodiments. As illustrated in FIG. 8A and FIG. 8B, the volumes of the acoustic suppression elements 710.1 through 710.n can be based upon diameters and/or lengths, or depths, of volumes of the acoustic suppression elements 710.1 through 710.n. As illustrated in FIG. 8A, each of the acoustic suppression elements 710.1 through 710.n can be characterized as having a substantially similar diameter d and/or a length L to one another. As such, the one or more resonant frequencies of the acoustic suppression elements 710.1 through 710.n having substantially similar diameters and/or lengths to one another can generate multiple noise suppression waves having substantially similar frequencies to one another. As illustrated in FIG. 8B, the acoustic suppression elements 710.1 through 710.n can be characterized as having different diameters and/or different lengths from one another to generate multiple noise suppression waves having substantially different frequencies from one another. For example, each of the acoustic suppression elements 710.1 through 710.n can be characterized as having a length from among four (4) different lengths. In some embodiments, one of the acoustic suppression elements from among the acoustic suppression elements 710.1 through 710.n can be characterized as having a length L1 that is greater than a length L2 of another acoustic suppression element from among the acoustic suppression elements 710.1 through 710.n. In these embodiments, the acoustic suppression element having the greater length L1 can resonate at one or more lower resonate frequencies then the acoustic suppression element having the lesser length L2 assuming that the diameter d1 is approximately equal to the diameter d2 as illustrated in FIG. 8B.

As illustrated in FIG. 8C, an acoustic suppression element 820 from among the acoustic suppression elements 710.1 through 710.n as described above in FIG. 8A and FIG. 8B, can be characterized as including a three-dimensional chamber 822 with a three-dimensional hollow cavity 824 formed therein. In some embodiments, a length L, or depth, of the three-dimensional chamber 822 is substantially similar to a length L, or depth, of the three-dimensional hollow cavity 824. In some embodiments, the three-dimensional chamber 822 and/or the three-dimensional hollow cavity 824 can be implemented as hexagonal prisms. However, those skilled in the relevant art(s) will recognize that the three-dimensional chamber 822 and/or the three-dimensional hollow cavity 824 can be implemented using other three-dimensional can shape, such as cubes, rectangular prisms, cylinders, and/or spheres to provide some examples, without departing from the spirit and scope of the present disclosure. In the exemplary embodiment illustrated in FIG. 8C, the acoustic suppression element 820 includes an opening 826 to allow the high-velocity, high-volume stream of gas 160 and/or the unwanted noise 162 that propagates through the passive acoustic absorption chamber 704 to enter the three-dimensional hollow cavity 824 with the second outer faceplate 708 enclosing the three-dimensional hollow cavity 824. In some embodiments, the opening 826 can be implemented using regular closed geometric openings, such as ellipses, hexagons, and/or circles to provide some examples. However, those skilled in the relevant art(s) will recognize that the opening 826 can be implemented using other regular closed geometric structures, irregular closed structures, such as one or more irregular polygons to provide an example, and/or any suitable combination of closed structures that will be apparent to those skilled in the relevant art(s) without departing from the spirit and scope of the present disclosure.

As illustrated in FIG. 8D, an acoustic suppression element 840 from among the acoustic suppression elements 710.1 through 710.n as described above in FIG. 8A through FIG. 8B, can be characterized as including the three-dimensional chamber 822 with the three-dimensional hollow cavity 824 formed therein as described above in FIG. 8C. In the exemplary embodiment illustrated in FIG. 8D, the acoustic suppression element 840 includes the opening 826 to allow the high-velocity, high-volume stream of gas 160 and/or the unwanted noise 162 that propagates through the passive acoustic absorption chamber 704 to enter the three-dimensional hollow cavity 824 with the second outer faceplate 708 enclosing the three-dimensional hollow cavity 824 in a substantially similar manner as described above in FIG. 8C. Moreover, the acoustic suppression element 840 includes a three-dimensional plug 844 to effectively tune the acoustic suppression element 840 to resonate at one or more different resonant frequencies. In some embodiments, a volume of the acoustic suppression element 840 can be controlled using the three-dimensional plug 844 to tune the acoustic suppression element 840. In these embodiments, a three-dimensional plug 844 having a greater length L2 can be used to cause the acoustic suppression element 840 to resonate at one or more higher resonate frequencies then a three-dimensional plug 844 having a lesser length L2. In some embodiments, the three-dimensional plug 844 can be implemented as a hexagonal prism. However, those skilled in the relevant art(s) will recognize that the three-dimensional plug 844 can be implemented using other three-dimensional shapes, such as cubes, rectangular prisms, cylinders, and/or spheres to provide some examples, without departing from the spirit and scope of the present disclosure. In some embodiments, the three-dimensional plug 844 can be implemented using one or more metals, one or more plastic materials, one or more resin materials, one or more composite materials, one or more ceramic materials, one or more fiberglass materials, one or more carbon fiber materials, one or more aramid fiber materials, one or more polyester resin materials, one or more thermoplastic composite materials, one or more cellulose fiber materials, one or more porous sound absorption materials such as acoustic foams, also referred to as studio foams, and/or one or more sound insulations, such as mineral wool, rock wool, among others.

### Exemplary Arrangements for the Exemplary Inner Faceplates and the Exemplary Active Acoustic Suppression Chambers

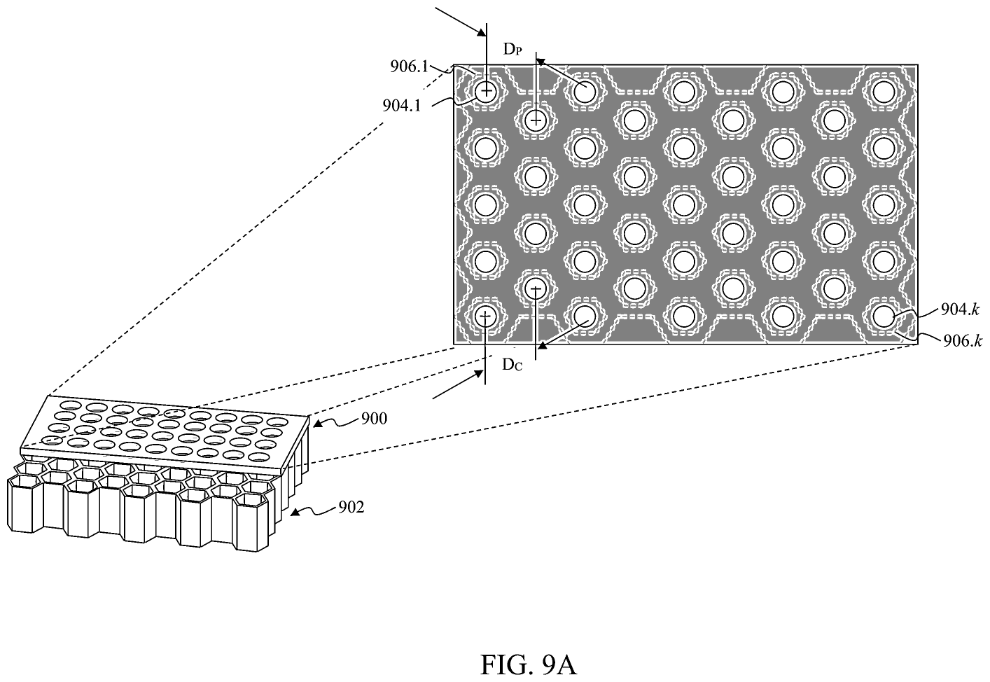

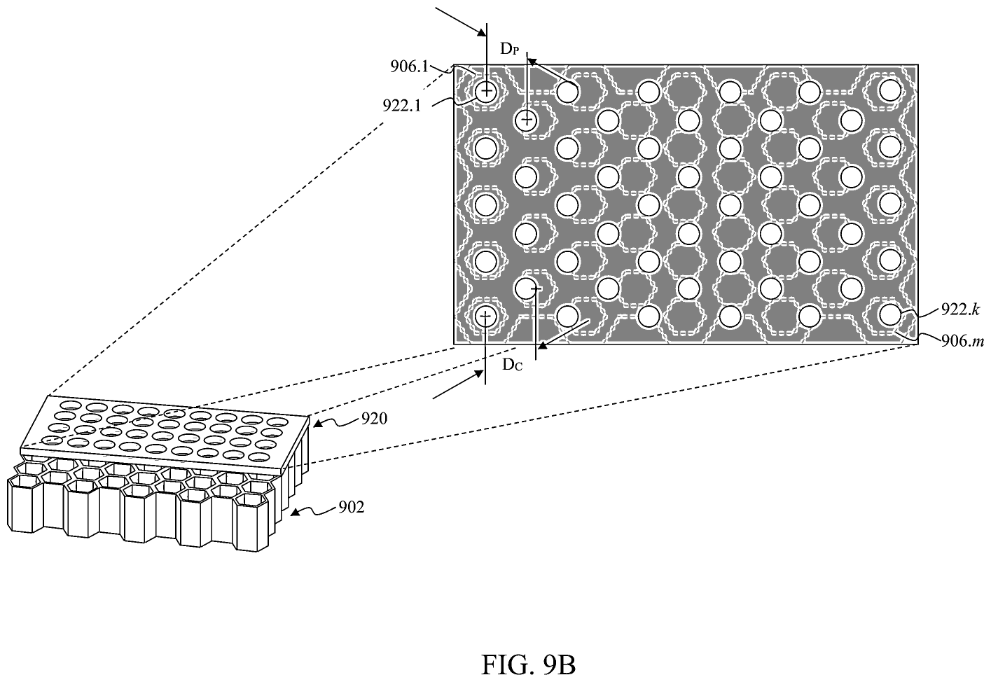

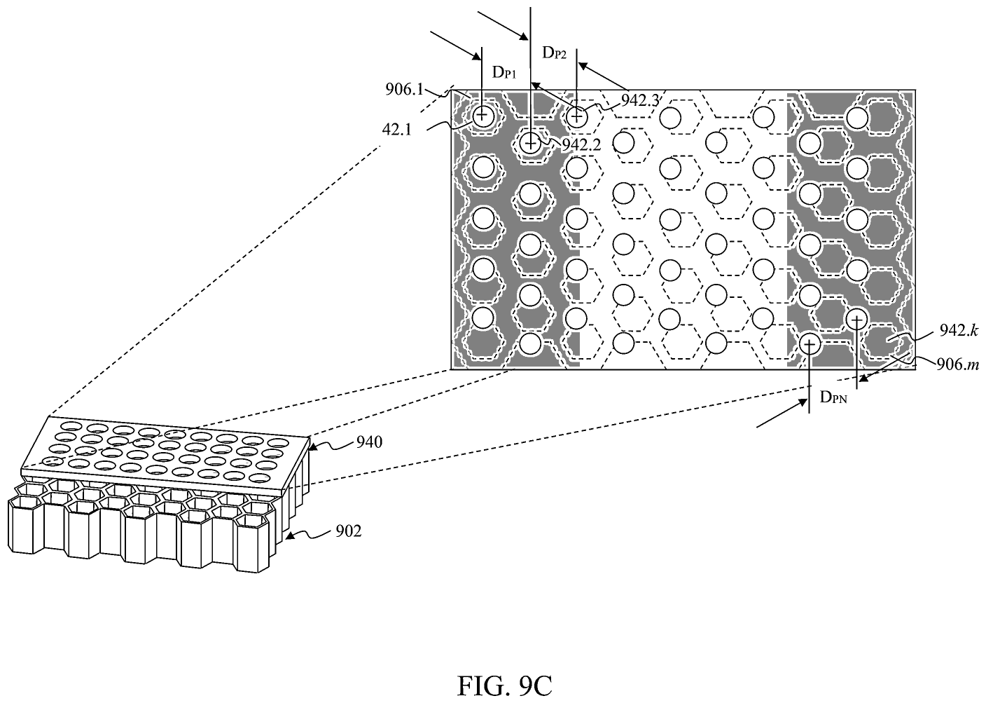

FIG. 9A through FIG. 9C graphically illustrate exemplary first inner face plates that can be implemented within the exemplary secondary noise suppressors described herein in accordance with some exemplary embodiments. As described herein, the high-velocity, high-volume stream of gas 160 and/or the unwanted noise 162 can propagate along one or more surfaces of a first inner faceplate, such as a first inner faceplate 900 as illustrated in FIG. 9A, a first inner faceplate 920 as illustrated in FIG. 9B, and/or a first inner faceplate 940 as illustrated in FIG. 9C. As described herein, the high-velocity, high-volume stream of gas 160 and/or the unwanted noise 162 can propagate through the first inner faceplate onto a passive acoustic suppression chamber, such as the passive acoustic absorption chamber 704 to provide an example. For simplicity, the passive acoustic suppression chamber is not illustrated in FIG. 9A through FIG. 9C. As described herein, the high-velocity, high-volume stream of gas 160 and/or the unwanted noise 162 that propagate through the passive acoustic suppression chamber can propagate onto an active acoustic suppression chamber, such as an active acoustic suppression chamber 902 as illustrated in FIG. 9A through FIG. 9C. The first inner faceplate 900, the first inner faceplate 920, and/or the first inner faceplate 940 can represent exemplary embodiments of the first inner faceplate 502. The active acoustic suppression chamber 902 can represent an exemplary embodiment of the active acoustic suppression chamber 506.

As illustrated in FIG. 9A, the first inner faceplate 900 can include perforations 904.1 through 904.k to allow some of the high-velocity, high-volume stream of gas 160 and/or the unwanted noise 162 to propagate through the first inner faceplate 900 onto their corresponding three-dimensional chambers 906.1 through 906.m of the active acoustic suppression chamber 902. Although the perforations 904.1 through 904.k are illustrated as being circles in FIG. 9A, those skilled in the relevant art(s) will recognize that the perforations 904.1 through 904.k can be implemented using any regular closed geometric openings, such as ellipses, hexagons, and/or diamonds to provide some examples, within the first inner faceplate 900 without departing from the spirit and scope of the present disclosure. In the exemplary embodiment illustrated in FIG. 9A, the perforations 904.1 through 904.k can be characterized as being uniformly separated from one another by a center-to-center spacing D_{P} as illustrated in FIG. 9A. As illustrated in FIG. 9A, each perforation from among the perforations 904.1 through 904.k is equidistant from neighboring, adjacent perforation from among the perforations 904.1 through 904.k by the center-to-center spacing D_{P}. Additionally, the corresponding three-dimensional chambers 906.1 through 906.m can be characterized as being separated from one another by a center-to-center spacing D_{C} as illustrated in FIG. 9A. In the exemplary embodiment illustrated in FIG. 9A, the center-to-center spacing D_{P} is approximately equal to the center-to-center spacing D_{C} such that the perforations 904.1 through 904.k centrally align with their corresponding three-dimensional chambers 906.1 through 906.m.

As illustrated in FIG. 9B, the first inner faceplate 920 can include perforations 922.1 through 922.k to allow some of the high-velocity, high-volume stream of gas 160 and/or the unwanted noise 162 to propagate through the first inner faceplate 920 onto their corresponding three-dimensional chambers 906.1 through 906.m of the active acoustic suppression chamber 902. Although the perforations 922.1 through 922.k are illustrated as being circles in FIG. 9B, those skilled in the relevant art(s) will recognize that the perforations 922.1 through 922.k can be implemented using any regular closed geometric openings, such as ellipses, hexagons, and/or diamonds to provide some examples, within the first inner faceplate 920 without departing from the spirit and scope of the present disclosure. In the exemplary embodiment illustrated in FIG. 9B, the perforations 922.1 through 922.k can be characterized as being uniformly separated from one another by the center-to-center spacing D_{P} as illustrated in FIG. 9B. As illustrated in FIG. 9B, each perforation from among the perforations 922.1 through 922.k is equidistant from neighboring, adjacent perforation from among the perforations 922.1 through 922.k by the center-to-center spacing D_{P}. Additionally, the corresponding three-dimensional chambers 906.1 through 906.m can be characterized as being separated from one another by the center-to-center spacing D_{C} as illustrated in FIG. 9B. In the exemplary embodiment illustrated in FIG. 9B, the center-to-center spacing D_{P} is less than the center-to-center spacing D_{C} such that the perforations 922.1 through 922.k can be characterized as being offset from their corresponding three-dimensional chambers 906.1 through 906.m. Although not illustrated, the center-to-center spacing D_{P} can be greater than the center-to-center spacing D_{C} such that the perforations 922.1 through 922.k can be similarly characterized as being offset from their corresponding three-dimensional chambers 906.1 through 906.m.

As illustrated in FIG. 9C, the first inner faceplate 940 can include perforations 942.1 through 942.k to allow some of the high-velocity, high-volume stream of gas 160 and/or the unwanted noise 162 to propagate through the first inner faceplate 940 onto their corresponding three-dimensional chambers 906.1 through 906.m of the active acoustic suppression chamber 902. Although the perforations 942.1 through 942.k are illustrated as being circles in FIG. 9C, those skilled in the relevant art(s) will recognize that the perforations 942.1 through 942.k can be implemented using any regular closed geometric openings, such as ellipses, hexagons, and/or diamonds to provide some examples, within the first inner faceplate 940 without departing from the spirit and scope of the present disclosure. In the exemplary embodiment illustrated in FIG. 9C, the perforations 942.1 through 942.k can be characterized as being variably separated from one another by variable center-to-center spacings D_{P} in a similar manner as described above. As illustrated in FIG. 9C, each perforation from among the perforations 942.1 through 942.k can be separated from neighboring, adjacent perforation from among the perforations 942.1 through 942.k by a corresponding center-to-center spacing D_{P} from among center-to-center spacings D_{P1} through D_{PN}. For example, as illustrated in FIG. 9C, a perforation 942.1 is separated from its neighboring, adjacent perforation 906.2 by a center-to-center spacing D_{P1} which is separated from its neighboring, adjacent perforation 906.2 by a center-to-center spacing D_{P2}. In this example, the center-to-center spacing D_{P1} can be different, for example, less than or greater than, the center-to-center spacing D_{P2} which results in the perforation 942.1 through the perforation 942.3 being variably separated from one another.

### CONCLUSION

The Detailed Description referred to accompanying figures to illustrate exemplary embodiments consistent with the disclosure. References in the disclosure to “an exemplary embodiment” or “exemplary embodiments” indicates that the exemplary embodiment(s) described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, characteristics, or the like of other exemplary embodiments whether or not explicitly described.

The Detailed Description is not meant to limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes and are not intended to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

The exemplary embodiments described within the disclosure can be described using spatially relative terms, such as “beneath,” “below,” “lower,” “above,” “on,” “upper,” and the like, for ease of description. These spatially relative terms are intended to encompass different orientations for these exemplary embodiments in addition to the orientation depicted in the figures. The exemplary embodiments described within may be otherwise oriented, for example, rotated 90 degrees or otherwise, and the spatially relative descriptors used herein may likewise be interpreted accordingly. The exemplary embodiments within the disclosure can be described using the terms “about,” “approximately,” “substantially,” or the like to indicate the value of a given quantity that can vary based on a particular technology. Based on the particular technology, the terms “about,” “approximately,” “substantially,” or the like can indicate a value of a given quantity that varies within, for example, 1-15% of the value (e.g., ±1%, ±2%, ±5%, ±10%, or ±15% of the value). Moreover, numerical values, including endpoints of ranges, can be expressed herein as approximations preceded by the terms “about,” “approximately,” “substantially,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

What is claimed is:

1. An air amplifier system, comprising:
air amplification engine configured to utilize energy from a high-pressure input stream of gas to accelerate a low-velocity input stream of gas to provide a high-velocity, high-volume input stream of gas;
a primary noise suppressor configured to shape the high-velocity, high-volume input stream of gas as the high-velocity, high-volume input stream of gas propagates through the primary noise suppressor to provide a high-velocity, high-volume stream of gas, the high-velocity, high-volume input stream of gas creating an unwanted noise as the high-velocity, high-volume input stream of gas propagates through the primary noise suppressor; and
a secondary noise suppressor, mechanically connected to the primary noise suppressor, configured to:
shape the high-velocity, high-volume stream of gas as the high-velocity, high-volume stream of gas stream of gas propagates through the secondary noise suppressor to provide a high-velocity, high-volume output stream of gas, and
suppress the unwanted noise exiting the primary noise suppressor.

2. The air amplifier system of claim 1, wherein the primary noise suppressor comprises a first three-dimensional shape including a first three-dimensional volume to shape the high-velocity, high-volume input stream of gas as the high-velocity, high-volume input stream of gas propagates through the primary noise suppressor, and
wherein the secondary noise suppressor comprises a second three-dimensional shape including a second three-dimensional volume to shape the high-velocity, high-volume stream of gas as the high-velocity, high-volume stream of gas stream of gas propagates through the secondary noise suppressor.

3. The air amplifier system of claim 2, wherein the first three-dimensional shape or the second three-dimensional shape are selected from a group consisting of a cube, a sphere, a cylinder, a pyramid, or a cone.

4. The air amplifier system of claim 1, wherein the primary noise suppressor and the secondary noise suppressor are configured and arranged to be centered with respect to one another about a central axis of the air amplifier system.

5. The air amplifier system of claim 4, wherein the primary noise suppressor is configured and arranged to partially overlap the secondary noise suppressor about the central axis of the air amplifier system.

6. The air amplifier system of claim 1, wherein the high-velocity, high-volume stream of gas stream of gas forms a lower pressure zone within the secondary noise suppressor to cause a second low-velocity input stream of gas to be drawn into the secondary noise suppressor, the low-velocity input stream of gas mixing with the unwanted noise exiting the primary noise suppressor to suppress the unwanted noise exiting the primary noise suppressor.

7. The air amplifier system of claim 1, wherein the unwanted noise is within an audible frequency range.

8. The air amplifier system of claim 1, wherein the secondary noise suppressor comprises:
a first faceplate to form an innermost assembly of the secondary noise suppressor that is situated within the secondary noise suppressor along a longitudinal axis of the secondary noise suppressor,
a passive acoustic absorption chamber, situated within the secondary noise suppressor along the longitudinal axis of the secondary noise suppressor, configured to at least some of the unwanted noise that propagates through the first faceplate,
an active acoustic suppression chamber, situated within the secondary noise suppressor along the longitudinal axis of the secondary noise suppressor, having a plurality of acoustic suppression elements that are normal to the longitudinal axis of the secondary noise suppressor, the plurality of acoustic suppression elements being configured to generate a plurality of noise suppression waves that destructively combine with at least some of the unwanted noise that propagates through the passive acoustic absorption chamber, and
a second faceplate to form an outermost assembly of the secondary noise suppressor that is situated within the secondary noise suppressor along the longitudinal axis of the secondary noise suppressor.

9. The air amplifier system of claim 8, wherein the passive acoustic absorption chamber comprises one or more porous sound absorption materials, one or more sound insulations, one or more acoustic fabrics, or one or more acoustic paints to absorb the at least some of the unwanted noise that propagates through the first faceplate.

10. The air amplifier system of claim 8, wherein the plurality of acoustic suppression elements is configured to vibrate at one or more resonant frequencies to generate the plurality of noise suppression waves at the one or more resonant frequencies that destructively combine with the at least some of the unwanted noise that propagates through the passive acoustic absorption chamber.

11. A multi-stage noise suppression system for an air amplifier system, the multi-stage noise suppression system comprising:
a primary noise suppressor configured to shape a first stream of gas as the first stream of gas propagates through the primary noise suppressor to provide a second stream of gas, the first stream of gas creating an unwanted noise as the first stream of gas propagates through the primary noise suppressor; and
a secondary noise suppressor, mechanically connected to the primary noise suppressor, configured to:
shape the second stream of gas as the second stream of gas stream of gas propagates through the secondary noise suppressor to provide a third stream of gas, and
suppress the unwanted noise exiting the primary noise suppressor.

12. The multi-stage noise suppression system of claim 11, wherein the primary noise suppressor comprises a first three-dimensional shape including a first three-dimensional volume to shape the first stream of gas as the first stream of gas propagates through the primary noise suppressor, and
wherein the secondary noise suppressor comprises a second three-dimensional shape including a second three-dimensional volume to shape the second stream of gas as the second stream of gas stream of gas propagates through the secondary noise suppressor.

13. The multi-stage noise suppression system of claim 12, wherein the first three-dimensional shape or the second three-dimensional shape are selected from a group consisting of a cube, a sphere, a cylinder, a pyramid, or a cone.

14. The multi-stage noise suppression system of claim 11, wherein the primary noise suppressor and the secondary noise suppressor are configured and arranged to be centered with respect to one another about a central axis of the multi-stage noise suppression system.

15. The multi-stage noise suppression system of claim 14, wherein the primary noise suppressor is configured and arranged to partially overlap the secondary noise suppressor about the central axis of the multi-stage noise suppression system.

16. The multi-stage noise suppression system of claim 11, wherein the second stream of gas stream of gas forms a lower pressure zone within the secondary noise suppressor to cause a second low-velocity input stream of gas to be drawn into the secondary noise suppressor, the low-velocity input stream of gas mixing with the unwanted noise exiting the primary noise suppressor to suppress the unwanted noise exiting the primary noise suppressor.

17. The multi-stage noise suppression system of claim 11, wherein the secondary noise suppressor comprises:
a first faceplate to form an innermost assembly of the secondary noise suppressor that is situated within the secondary noise suppressor along a longitudinal axis of the secondary noise suppressor,
a passive acoustic absorption chamber, situated within the secondary noise suppressor along the longitudinal axis of the secondary noise suppressor, configured to absorb at least some of the unwanted noise that propagates through the first faceplate,
an active acoustic suppression chamber, situated within the secondary noise suppressor along the longitudinal axis of the secondary noise suppressor, having a plurality of acoustic suppression elements that are normal to the longitudinal axis of the secondary noise suppressor, the plurality of acoustic suppression elements being configured to generate a plurality of noise suppression waves that destructively combine with at least some of the unwanted noise that propagates through the passive acoustic absorption chamber, and
a second faceplate to form an outermost assembly of the secondary noise suppressor that is situated within the secondary noise suppressor along the longitudinal axis of the secondary noise suppressor.

18. The multi-stage noise suppression system of claim 11, wherein the passive acoustic absorption chamber comprises one or more porous sound absorption materials, one or more sound insulations, one or more acoustic fabrics, or one or more acoustic paints to absorb the at least some of the unwanted noise that propagates through the first faceplate.

19. The multi-stage noise suppression system of claim 11, wherein the plurality of acoustic suppression elements is configured to vibrate at one or more resonant frequencies to generate the plurality of noise suppression waves at the one or more resonant frequencies that destructively combine with the at least some of the unwanted noise that propagates through the passive acoustic absorption chamber.

20. A secondary noise suppressor of a multi-stage noise suppression system for an air amplifier system, the secondary noise suppressor comprising:
a first faceplate situated within a hallow cavity of the primary noise suppressor along a longitudinal axis of the primary noise suppressor, the first faceplate having a plurality of perforations configured to allow an unwanted noise generated by a stream of gas as the stream of gas propagates through the primary noise suppressor to propagate through the first faceplate;
a second faceplate to form an outermost assembly of the secondary noise suppressor that is situated within the secondary noise suppressor along the longitudinal axis of the secondary noise suppressor;
a passive acoustic absorption chamber, situated within the hallow cavity of the primary noise suppressor along the longitudinal axis of the primary noise suppressor between the first faceplate and the second inner faceplate, comprising one or more porous sound absorption materials, one or more sound insulations, one or more acoustic fabrics, or one or more acoustic paints to absorb at least some of the unwanted noise that propagates through the first faceplate; and
an active acoustic suppression chamber situated within the hallow cavity of the primary noise suppressor along the longitudinal axis of the primary noise suppressor between the first faceplate and the second inner faceplate, the active acoustic suppression chamber having a plurality of acoustic suppression elements that are normal to the longitudinal axis of the primary noise suppressor, the plurality of acoustic suppression elements being configured to generate a plurality of noise suppression waves that destructively combine with at least some of the unwanted noise that propagates through the passive acoustic absorption chamber.
